(19) United States
(12) Patent Application Publication
(10) Pub. No.: US 2006/0261737 A1
(43) Pub. Date: Nov. 23, 2006

(54) Double-sided adhesive element for a display apparatus and plasma display apparatus having the same

(76) Inventor: Sung-Won Bae, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/437,376

(22) Filed: May 19, 2006

(30) Foreign Application Priority Data
May 21, 2005 (KR) 10-2005-0042780

(51) Int. Cl. H01J 17/49

(52) U.S. Cl. 313/582

(57) ABSTRACT

A double-sided adhesive element for a plasma display apparatus having a structure that allows easy separation of a chassis base from a plasma display panel, and a plasma display apparatus having the double-sided adhesive element are disclosed. In one embodiment, the plasma display apparatus includes a double-sided adhesive element interposed between the plasma display panel and the chassis base, and one surface of which is attached to the plasma display panel and the other surface of which is attached to the chassis base, wherein the double-sided adhesive element includes a first adhesion layer bonded on one side thereof to be bonded to the plasma display panel, a second adhesion layer bonded on the other side thereof to be bonded to the chassis base, and a base material layer interposed between the first adhesion layer and the second adhesion layer, the base material layer having a lower shear stress than the first adhesion layer and the second adhesion layer.

### CROSS-REFERENCE TO RELATED PATENT APPLICATION

This application claims the benefit of Korean Patent Application No. 10-2005-0042780, filed on May 21, 2005, in the Korean Intellectual Property Office, the disclosure of which is incorporated herein in its entirety by reference.

### BACKGROUND OF THE INVENTION

1. Field of the Invention

The present invention relates to a double-sided adhesive element for a display apparatus and a plasma display apparatus having the same, and more particularly, to a double-sided adhesive element for a plasma display apparatus to support the plasma display apparatus on a chassis base, and a plasma display apparatus having the same.

2. Description of the Related Technology

A plasma display apparatus is a flat display device for displaying images using a discharge effect. Since it can easily be made into a large thin screen with a wide viewing angle, the plasma display apparatus is expected to be a popular large screen flat display device. The plasma display apparatus includes a plasma display panel formed of glass, and a chassis base to support the plasma display panel.

FIG. 1 is a cross-sectional view of a supporting structure of a conventional plasma display panel. Referring to FIG. 1, a plasma display panel 11 includes a front substrate 12 and a rear substrate 13, and a thermal conductive sheet 14 is attached to the rear surface of the rear substrate 13. The plasma display panel 11 is typically supported by a chassis base 15 formed of metal. The chassis base 15 supports at least one circuit board 17 which is located over the rear surface of the chassis base 15. The circuit board 17 drives the plasma display panel 11.

The plasma display panel 11 is attached to the front surface of the chassis base 15 using double-sided adhesive elements 16. The double-sided adhesive elements 16 extend horizontally and vertically while avoiding portions corresponding to the thermal conductive sheet 14. That is, the double-sided adhesive elements 16 and the thermal conduction sheet 14 do not overlap each other, and the double-sided adhesive elements 16 are spaced a predetermined distance apart from each other.

The double-sided adhesive element 16 is a single layer formed of one material, and includes a first adhesion surface 16a on one side that contacts the plasma display panel 11, and a second adhesion surface 16b on the other side that contacts the chassis base 15.

Recently, international environmental regulation for preventing environmental pollutions has become stricter, so plasma display apparatuses should be separated and collected according to certain characteristics, e.g., same or similar materials. To achieve this, the plasma display panel 11 including the front substrate 12 and the rear substrate 13 must be able to be separated from the chassis base 15, which is typically formed of metal.

However, it is difficult to separate the plasma display panel 11 from the chassis base 15, since they are coupled by the double-sided adhesive element 16 which is formed in a single layer and has a high shear stress. Therefore, it takes a long time to separate them, and an additional device is required.

### SUMMARY OF CERTAIN INVENTIVE ASPECTS

One aspect of the present invention provides a double-sided adhesive element for a plasma display apparatus, and a plasma display apparatus having the double-sided adhesive element. In one embodiment, the double-sided adhesive element has a structure that allows the easy separation of a chassis base from a plasma display panel.

Another aspect of the present invention provides a double-sided adhesive element comprising: a base material layer, a first adhesion layer having two opposing surfaces, wherein one surface is bonded to one side surface of the base material layer and the other surface of the first adhesion layer is bonded to a display panel and a second adhesion layer having two opposing surfaces, wherein one surface is bonded to the other side of the base material layer opposite to the first adhesion layer and the other surface of the second adhesion layer is bonded to a support element configured to support the display panel, and wherein the base material layer has a lower shear stress than the first adhesion layer and the second adhesion layer

The base material layer may be formed of a porous material. In this case, the base material layer may be formed of a foam material.

The first adhesion layer and the second adhesion layer may be formed of acryl or silicon.

Another aspect of the present invention provides a plasma display apparatus comprising: a plasma display panel, a chassis base which is located on one side of the plasma display panel and supports the plasma display panel and a double-sided adhesive element interposed between the plasma display panel and the chassis base, and one surface of which is attached to the plasma display panel and the other surface of which is attached to the chassis base, wherein the double-sided adhesive element includes i) a first adhesion layer bonded on one side thereof to be bonded to the plasma display panel, ii) a second adhesion layer bonded on the other side thereof to be bonded to the chassis base, and iii) a base material layer interposed between the first adhesion layer and the second adhesion layer, the base material layer having a lower shear strength than the first adhesion layer and the second adhesion layer.

The base material layer may have a thermal conductivity of at least 0.1 W/mK.

Another aspect of the invention provides a plasma display apparatus, comprising: a double-sided adhesive element interposed between and connecting a plasma display panel and a chassis base, wherein the double-sided adhesive element includes a plurality of adhesive layers.

### BRIEF DESCRIPTION OF THE DRAWINGS

Embodiments of the present invention will be described with reference to the attached drawings.

FIG. 1 is a cross-sectional view of a supporting structure of a conventional plasma display panel.

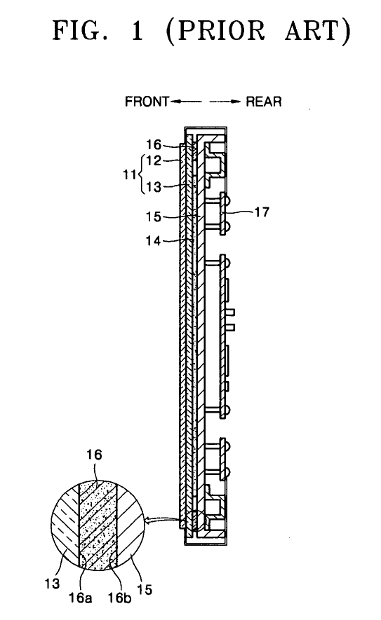

FIG. 2 is an exploded perspective view of a plasma display apparatus having a double-sided adhesive element according to an embodiment of the present invention.

FIG. 3 is a cross-sectional view taken along line III-III of FIG. 2.

FIG. 4 is a cross-sectional view showing the separation of the double-sided adhesive element of FIG. 2.

### DETAILED DESCRIPTION OF CERTAIN INVENTIVE EMBODIMENTS

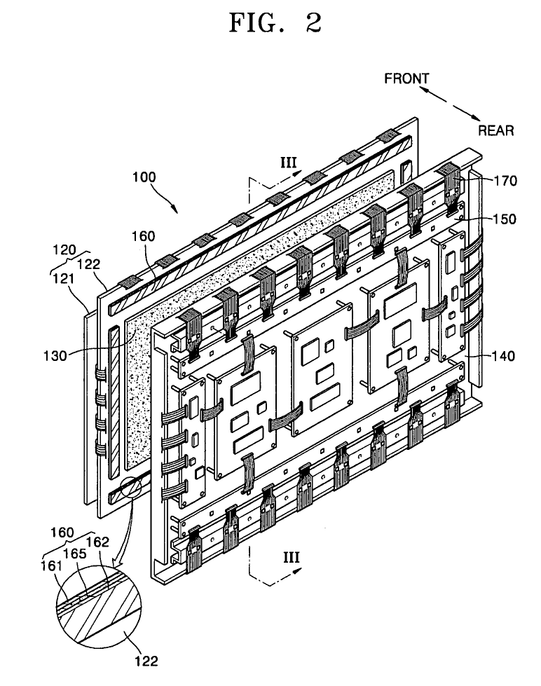

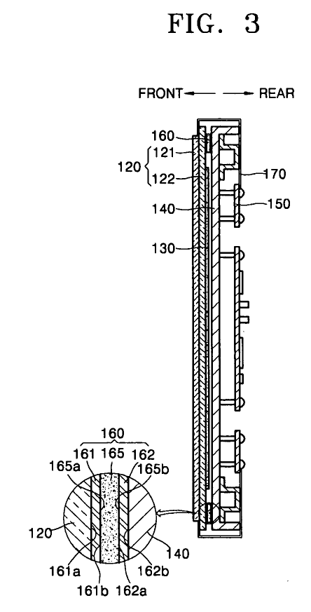

FIG. 2 is an exploded perspective view of a plasma display apparatus having a double-sided adhesive element according to an embodiment of the present invention, and FIG. 3 is a cross-sectional view taken along line III-III of FIG. 2.

In one embodiment, a plasma display apparatus 100 includes a plasma display panel 120, a chassis base 140 that supports the plasma display panel 120, and a double-sided adhesive element 160.

The plasma display panel 120 includes a front substrate 121 and a rear substrate 122 coupled to the front substrate 121. Here, although it is not shown in the drawing, the plasma display panel 120 generally includes a plurality of barrier ribs, sustain electrode pairs, address electrodes, and fluorescent layers, and displays an image using a plasma discharge generated between electrodes.

A chassis base 140 is located on the rear side of the plasma display panel 120. In one embodiment, the plasma display panel 120 and the chassis base 140 are coupled by the double-sided adhesive element 160.

Also, a circuit unit 150 can be located on the back side of the chassis base 140. The circuit unit 150 drives the plasma display panel 120, and may include a plurality of circuit boards, such as a logic board, a power source board, and a logic buffer board. The circuit unit 150 is connected to the electrodes of the plasma display panel 120 by signal transmission members 170.

In one embodiment, a thermal conductive sheet 130 can be interposed between the plasma display panel 120 and the chassis base 140. In this case, as depicted in FIG. 3, the thermal conductive sheet 130 transfers heat generated by the plasma display panel 120 to the environment or to the chassis base 140. One surface of the thermal conductive sheet 130 is attached to the plasma display panel 120, and the other surface may contact the chassis base 140 or, as depicted in FIG. 3, may not contact any element.

In one embodiment, the double-sided adhesive element 160 includes a first adhesion layer 161, a second adhesion layer 162, and a base material layer (or an intermediate layer) 165. The front surface 161a of the first adhesion layer 161 is bonded to the plasma display panel 120. The rear surface 162b of the second adhesion layer 162 is bonded to the chassis base 140. That is, both the first adhesion layer 161 and the second adhesion layer 162 serve as adhesives, and in this case, they can be an adhesive formed of, for example, acryl or silicon. In another embodiment, the double-sided adhesive element 160 may include a plurality of adhesion layers, for example, two, four, or more. In this embodiment, at least one adhesion layer may have a lower shear stress than the remaining adhesion layers.

In one embodiment, the base material layer 165 is formed between the first adhesion layer 161 and, the second adhesion layer 162. The front surface 165a of the base material layer 165 bonds to the rear surface 161b of the first adhesion layer 161, and the rear surface 165b of the base material layer 165 bonds to the front surface 162b of the second adhesion layer 162. In one embodiment, the base material layer 165 has a lower shear stress than the first adhesion layer 161 and the second adhesion layer 162. In one embodiment, the base material layer 165 is formed of a material having a texture that can be destroyed by a shear force more easily than the first adhesion layer 161 and the second adhesion layer 162. A shear force denotes a force applied in a direction substantially parallel to a rear substrate of a plasma display panel. A shear stress denotes a stress that can stand the shear force.

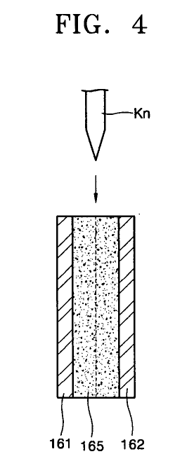

Therefore, when the plasma display panel 120 and the chassis base 140 need to be separated, this can easily be achieved as depicted in FIG. 4 by separating the base material layer 165 into two layers by applying a shear force smaller than the shear stress of the first adhesion layer 161 and the second adhesion layer 162. In one embodiment, a means Kn to apply the shear force to the base material layer 165 can be a knife.

In one embodiment, the base material layer 165 is formed of a material having a strong resistance to normal tension and compression that have directions substantially perpendicular to the direction of the shear force. In one embodiment, the base material layer 165 is formed of the same material (e.g., acryl or silicon) as the first and second adhesion layers 161 and 162. In another embodiment, the base material layer 165 is formed of a different material from the adhesion layers 161 and 162. In either embodiment, the base material layer 165 has a lower shear stress than the adhesion layers 161 and 162. In one embodiment, the base material layer 165 may have some elasticity to increase the adhesive strength between the first adhesion layer 161 and the second adhesion layer 162. In one embodiment, the base material layer 165 included in the double-sided adhesive element 160 forms a gap between the chassis base 140 and the plasma display panel 120 within a predetermined range so that the plasma display panel 120 and the chassis base 140 can be easily separated from each other without damage. In this embodiment, the base material layer 165 may not be excessively elastic.

In one embodiment, the double-sided adhesive element 160 may have an ability to dissipate heat generated by the plasma display panel 120 to the environment or to the chassis base 140. For this purpose, the base material layer 165 may be formed of a material having thermal conductivity of 0.1 W/mK or more.

In one embodiment, the base material layer 165 is formed of a porous material. This is because a porous material can be readily separated when the shear force is applied, can maintain a certain elasticity due to pores formed in the central portion, and the small pores can improve the thermal conductivity of the base material layer 165 to dissipate heat to the outside. In another embodiment, the base material layer 165 is formed of a foam material.

Referring to FIGS. 2 and 3 again, when the double-sided adhesive element 160 having the base material layer 165 is used in the plasma display apparatus 100, noise generated by the plasma display panel 120 can be reduced. That is, a discharge gas is filled in a sealed space between the front substrate 121 and the rear substrate 122. It has been known that there are some air gaps generated between the front substrate and the rear substrate, especially between barrier ribs and the front substrate, due to the pressure difference of the discharge gas of the plasma display panel 120 and external gas. When the plasma display panel 120 is driven, noise is generated by the vibration of the air gap, and if the noise is directly transmitted to the chassis base 140, noises can be generated more seriously. However, in one embodiment of the present invention, since the base material layer 165 is formed of, for example, a porous material, vibrations generated at end parts of barrier ribs of the edges of the plasma display panel 120 due to the air gap can be absorbed by the base material layer 165, thereby reducing the noise of the plasma display panel 120. That is, the energy of the noise and vibration from the plasma display panel 120 is absorbed by the pores of the base material layer 165.

In one embodiment, when the thermal conductive sheet 130 is interposed between the plasma display panel 120 and the chassis base 140, the double-sided adhesive element 160 may be located between the plasma display panel 120 and the chassis base 140 without overlapping with the thermal conductive sheet 130.

In one embodiment, the double-sided adhesive element 160 may be thicker than the thermal conductive sheet 130. In this case, a gap can be formed between the thermal conductive sheet 130 and the chassis base 140. Then, heat generated by the plasma display panel 120 can be transferred to the gap through the thermal conductive sheet 130. The heat transferred to the gap can be cooled by the convection of air or dissipated to the environment through the base material layer 165.

In one embodiment, the double-sided adhesive element 160 has high normal stress to strongly join the plasma display panel 120 to the chassis base 140. In one embodiment, the double-sided adhesive element 160 has a shear strength less than the normal stress so that the plasma display panel 120 and the chassis base 140 can be readily separated for disposal. Therefore, in one embodiment, the double-sided adhesive element 160 can reduce separation time, allow the elements to be more easily repaired, and comply with environmental regulations.

In one embodiment, the double-sided adhesive element 160 can transfer heat generated by the plasma display panel 120 to the environment or to the chassis base 140, and absorb noises of the plasma display panel 120.

In one embodiment, the double-sided adhesive element is applied to a plasma display panel. In another embodiment, the double-sided adhesive element may be used to couple a display panel included in the other display apparatuses, such as LCDs, field emission displays (FEDs), organic electroluminescent displays (OLEDs), etc., with a supporting element for supporting the display panel.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A double-sided adhesive element for a display apparatus, comprising:
a base material layer;
a first adhesion layer having two opposing surfaces, wherein one surface is bonded to one side surface of the base material layer and the other surface of the first adhesion layer is bonded to a display panel; and
a second adhesion layer having two opposing surfaces, wherein one surface is bonded to the other side of the base material layer opposite to the first adhesion layer and the other surface of the second adhesion layer is bonded to a support element configured to support the display panel,
wherein the base material layer has a lower shear stress than the first adhesion layer and the second adhesion layer.

2. The double-sided adhesive element of claim 1, wherein the base material layer is formed of a porous material.

3. The double-sided adhesive element of claim 2, wherein the base material layer is formed of a foam material.

4. The double-sided adhesive element of claim 1, wherein the first adhesion layer and the second adhesion layer are formed of acryl or silicon.

5. The double-sided adhesive element of claim 1, wherein the base material layer has a thermal conductivity of at least 0.1 W/mK.

6. A plasma display apparatus, comprising:
a plasma display panel;
a chassis base which is located on a side of the plasma display panel and supports the plasma display panel; and
a double-sided adhesive element interposed between the plasma display panel and the chassis base, and one surface of which is attached to the plasma display panel and the other surface of which is attached to the chassis base, wherein
the double-sided adhesive element includes i) a first adhesion layer bonded on one side thereof to be bonded to the plasma display panel, ii) a second adhesion layer bonded on the other side thereof to be bonded to the chassis base, and iii) a base material layer interposed between the first adhesion layer and the second adhesion layer, the base material layer having a lower shear strength than the first adhesion layer and the second adhesion layer.

7. The plasma display apparatus of claim 6, wherein the base material layer is formed of a porous material.

8. The plasma display apparatus of claim 7, wherein the base material layer is formed of a foam material.

9. The plasma display apparatus of claim 6, wherein the first adhesion layer and the second adhesion layer are formed of acryl or silicon.

10. The plasma display apparatus of claim 6, wherein the base material layer has a thermal conductivity of at least 0.1 W/mK.

11. The plasma display apparatus of claim 6, further comprising a thermal conductive sheet having a bonded surface on the rear surface of the plasma display panel, that does not overlap with the double-sided adhesive element.

12. A plasma display apparatus, comprising:
a double-sided adhesive element interposed between and connecting a plasma display panel and a chassis base, wherein the double-sided adhesive element includes a plurality of adhesive layers.

13. The plasma display apparatus of claim 12, wherein at least one of the plurality of adhesive layers has a different shear stress than the remaining adhesive layers.

14. The plasma display apparatus of claim 12, wherein the double-sided adhesive element includes three adhesive layers formed in a stack, and wherein the intermediate layer has a different shear stress than the remaining two layers.

15. The plasma display apparatus of claim 14, wherein the intermediate layer has a lower shear stress than the remaining two layers.

16. The plasma display apparatus of claim 12, wherein the double-sided adhesive element includes:
a first adhesive layer having two opposing surfaces, wherein one surface is configured to adhere to the plasma display panel;
a second adhesive layer having two opposing surfaces, wherein one surface is configured to adhere to the chassis base; and
an intermediate layer formed between and adhered to the other surfaces of the first and second adhesive layers, wherein the intermediate layer is formed of a material having a texture that can be more easily ripped by an external force than the first and second adhesive layers.

17. The plasma display apparatus of claim 16, wherein the external force is a shear stress which is applied in a direction substantially parallel to the first and second adhesive layers.

18. The plasma display apparatus of claim 17, wherein the intermediate layer is formed of a material having a strong resistance to normal tension and compression that have directions substantially perpendicular to the direction of the shear stress.

19. The plasma display apparatus of claim 16, wherein the intermediate layer has elasticity so as to increase the adhesive strength between the first and second adhesive layers.

20. The plasma display apparatus of claim 16, wherein the intermediate layer is formed of a foam material or a porous material.
